(19) United States
(12) Patent Application Publication
(10) Pub. No.: US 2012/0254773 A1
(43) Pub. Date: Oct. 4, 2012

(54) TOUCH SCREEN BASED INTERACTIVE MEDIA SHARING

(75) Inventor: Subramanian Viswanathan, Chennai (IN)

(73) Assignee: Subramanian V, Chennai (IN)

(21) Appl. No.: 13/340,368

(22) Filed: Dec. 29, 2011

Related U.S. Application Data
(60) Provisional application No. 61/430,553, filed on Jan. 7, 2011.

(51) Int. Cl. G06F 3/048

(52) U.S. Cl. 715/753

(57) ABSTRACT

Systems and methods for interactive media sharing are described. In one implementation, a method for interactive media sharing includes facilitating participation in a session where the session is conducted among a plurality of touch screen user devices (TSUDs) connected to each other. The method may further include sending primary media content to one or more of the plurality of the TSUDs in real time. The method may further include receiving edited media content from at least one of the plurality of the TSUDs in real time, wherein the edited media content comprises secondary media content overlaid on the primary media content and where the secondary media content comprises first handwritten content provided through a touch screen and first multimedia data.

This application claims priority to Provisional Patent Application No. 61/430,553, filed Jan. 7, 2011, which is incorporated herein by reference.

### FIELD OF INVENTION

The present subject matter relates to media sharing in real time and, particularly, but not exclusively, to touch screen based interactive media sharing in real time over a communication network.

### BACKGROUND

In the recent years, with the advent of the information age and the wide usage of communication technology, there have been developments in learning and media sharing environment leading to the evolution of e-sharing. E-sharing generally refers to sharing and interacting online through a communication network, anytime and anywhere. E-sharing may be used for applications, such as learning and training involving the delivery of just-in-time information and the receiving of guidance from teachers, lecturers, or instructors. Commonly, two basic types of e-sharing methods are utilized, asynchronous e-sharing and synchronous e-sharing. Asynchronous e-sharing is used when participants are not online at the same time and the sharing is facilitated by media, such as e-mail and discussion boards.

Recent improvements in technology and increasing connectivity and bandwidth capabilities of networks have led to the growing popularity of synchronous e-sharing. Synchronous e-sharing is commonly supported by multimedia capability, such as videoconferencing and instant messaging. Synchronous e-sharing may therefore be considered to be more interactive and social because of a live experience that helps participants to feel like true participants rather than isolated ones. Thus, synchronous e-sharing provides real time learning and sharing experience and has precluded the need for participants to be in one physical location at the same time.

During synchronous e-sharing, for effective real time and online collaboration, active participation of all the participants is required. Collaboration helps in making the e-sharing experience more interactive and lively and helps in active discussions and resolution of doubts.

### SUMMARY

This summary is provided to introduce concepts related to touch screen based interactive media sharing over a communication network. This summary is not intended to identify essential features of the claimed subject matter nor is it intended for use in determining or limiting the scope of the claimed subject matter.

In one implementation, a method for interactive media sharing is described. The method for interactive media comprises sharing between a plurality of participants, where each participant having a touch screen user device (TSUD). The method includes participating in a session, wherein the session is conducted among a plurality of TSUDs communicatively coupled to each other, and wherein the plurality of TSUDs comprises at least one master touch screen user device (MTSUD). The method further includes receiving primary media content from at least one of the plurality of the TSUDs in real time. The method further includes overlaying secondary media content on the primary media content to generate edited media content in real time, wherein the secondary media content is true multimedia content comprising first handwritten content provided through a touch screen and first multimedia data; and broadcasting the edited media content to the plurality of the TSUDs in real time, wherein the broadcast is controlled by the MTSUD.

In another implementation, a method for interactive media sharing between a plurality of participants where each participant has a touch screen user device (TSUD) is described. The method may include participating in a session, wherein the session is conducted among a plurality of touch screen user devices (TSUDs) communicatively coupled to each other, and wherein the plurality of TSUDs comprises at least one client touch screen user device (CTSUD). Further, the method may include sending primary media content to one or more of the plurality of the TSUDs in real time, wherein the primary media content comprises one or more of text documents, PDF documents, presentations, chapters of e-books, scanned copy of physical material, question papers, quizzes, video content, and inputs provided through the TSUD on an e-canvas including handwritten annotations, graphical inputs, and markup points. The method may also include receiving edited media content from at least one of the plurality of the TSUDs in real time, wherein the edited media content comprises secondary media content overlaid on the primary media content, and wherein the secondary media content comprises first handwritten content provided through a touch screen and first multimedia data; and providing the edited media content to the one or more TSUDs of the session, wherein the edited media content is projected on the touch screen of each of the one or more TSUDs in real time.

### BRIEF DESCRIPTION OF THE FIGURES

The detailed description is described with reference to the accompanying figures. In the figures, the left-most digit(s) of a reference number identifies the figure in which the reference number appears for the first time. The same reference numbers are used throughout the figures to reference like features and components irrespective of the figure in which they are used after being introduced for the first time in any of the figures. Some embodiments of system and/or methods in accordance with embodiments of the present subject matter are now described, by way of example only, and with reference to the accompanying figures, in which:

FIG. 1 illustrates a real time virtual communication environment, according to an embodiment of the present subject matter;

FIG. 2 schematically illustrates components of various entities providing interactive media sharing, in accordance with an embodiment of the present subject matter;

FIGS. 3(a) and 3(b) illustrate an e-canvas of a TSUD, according to an embodiment of the present subject matter;

FIG. 4 illustrates a swiveling and change of orientation of a dual TSUD, according to an embodiment of the present subject matter;

FIGS. 5(a) and 5(b) illustrate interactive sharing of media content, according to an embodiment of the present subject matter;

FIG. 6 illustrates simultaneous sharing of an e-canvas, in accordance with and embodiment of the present subject matter;

FIG. 7 illustrates an interactive assessment scenario, in accordance with an embodiment of the present subject matter;

FIGS. 8(a) and 8(b) depict the display area of a TSUD, in accordance with an embodiment of the present subject matter;

FIG. 9 shows hand gestures for using a TSUDs, in accordance with an embodiment of the present subject matter;

FIGS. 10(a) and 10(b) depicts the development of animated content on a TSUD, in accordance with an embodiment of the present subject matter;

FIG. 11 shows the replay of stored media content on a TSUD, in accordance with an embodiment of the present subject matter;

FIG. 12 illustrates real time virtual collaborative learning using a TSUD, in accordance with an embodiment of the present subject matter;

FIG. 13(a) and FIG. 13(b) illustrate methods for interactive media sharing, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for touch screen based interactive media sharing over a communication network are described. The methods can be implemented in various communication devices capable of receiving inputs from a touch screen and communicating through various networks. Although the description herein is with reference to a particular touch screen device communicating over a particular network, the methods and systems may be implemented on other devices in other networks as well, albeit with a few variations, as will be understood by a person skilled in the art.

The system, according to the present subject matter, may comprise of touch screen based devices having touch sensitive screens, such as resistive touch screen, capacitive touch screen, surface acoustic touch screen, surface capacitive touch screen, projected capacitive touch screen, mutual capacitive touch screen, self-capacitive touch screen, infrared touch screen, optical imaging touch screen, piezo-electric touch screen, and acoustic pulse recognition touch screen. The methods described herein can be implemented in devices that are capable of supporting touch screen inputs and communicating over networks.

The devices described herein may also communicate over wireless networks, wired networks, or a combination thereof. The connection can in turn be implemented as one of the different types of networks, such as intranet, telecom network, electrical network, local area network (LAN), wide area network (WAN), Virtual Private Network (VPN), internetwork, Global Area Network (GAN), the Internet.

The telecom network may utilize different radio communication networks, such as Code Division Multiple Access (CDMA), Time Division Multiple Access (TDMA), Frequency Division Multiple Access (FDMA), Orthogonal Frequency-Division Multiple Access (OFDMA), Single Carrier Frequency Division Multiple Access (SC-FDMA) and other systems. A CDMA system may implement a radio technology, such as Universal Terrestrial Radio Access (UTRA), and cdma2000. A UTRA network includes variants of CDMA. A cdma2000 standard includes IS-2000, IS-95 and IS-856 standards. A TDMA system may implement a radio technology, such as Global System for Mobile Communications (GSM). An OFDMA system may implement a radio technology, such as Evolved UTRA (E-UTRA), Ultra Mobile Broadband (UMB), IEEE 802.20, IEEE 802.16 (WiMAX), 802.11 (WiFi™), Flash-OFDM®, etc. UTRA and E-UTRA are part of Universal Mobile Telecommunication System (UMTS).

Generally, sessions of collaborative interactions among a plurality of individuals in a real world or physical environment may include exchange or sharing of ideas by way of oral communication, body gestures, or media exchange. Participants of such sessions in a physical environment may use a variety of communication means, such as markers to write on a white board, overhead projector to display electronic slides, and paper documents for distribution. A convener, who presides over such a session, may deliver his/her content in the physical environment as described above, while the participants either communicate with the convener or jot down notes individually on their physical medium using writing instruments. Similarly, in classrooms, students usually jot down what the instructor communicates. Though some of the notes taken by individuals may go beyond what had been written on the board or displayed on the screen by the instructor or convener, it is not practical to share notes of all the individuals among each other for the benefit of everyone. Further, in a physical environment, participants have to be present at the same location.

With the advent of technology and the increasing usage of internet, it is now possible for the participants to participate in a session from anywhere, without having to be physically present at the same location. The participants can attend the session using a real time virtual environment, where participants may share knowledge and ideas through e-sharing. Through e-sharing, participants can attend classrooms, meetings, conferences, and training sessions, either in an asynchronous mode or in a synchronous mode. In virtual classrooms, implemented through e-sharing, the content provided by the instructor is generally static wherein a pre-prepared training material is delivered monotonously to the students.

Although, through the e-sharing, exchange of ideas and sharing of knowledge has become convenient and easy, e-sharing does not facilitate the enhancement of the collaboration experience of participants. Further, such virtual classrooms do not provide any other mode of interaction, apart from conventional audio and visual communication that facilitates interaction between participants. Further, there is a little scope for context-specific annotation on the training material.

Similarly, electronic media is not used effectively for the students to collaborate and therefore benefit from each other. Although instant messaging software facilitates students to communicate with each other from different geographic locations, the available software do not facilitate the blending of the messaging content with the teaching material. Although, through such techniques, ideas and opinions of participants can be aggregated and shared, such techniques and environments are either cumbersome to implement or do not provide the participants with flexibility and ease of interaction including the capability of providing responses in real time.

According to an implementation of the present subject matter, interactive media sharing in a real time virtual environment is described. Further, devices and methods of the real time virtual environment may facilitate collaborative sessions for interactive media sharing over a communication network. The collaborative session involves interaction of a plurality of participants for a purpose, such as education, training, conference, workshop, and meeting. The interactions may include communication from one participant to many participants, or from many participants to many participants. The communication may be in any form, such as voice, text, data, images, and body language including gestures using a variety of means, such as touch screen for writing or drawing images by hand, video conferencing for body language, voice file for recording voice, text messaging, and annotation.

The described methods may facilitate multiple participants to interact in real time with each other including with the convener of the session. In one implementation, the participants may share an e-canvas where the e-canvas may be edited with true multimedia inputs provided from the touch screen in a manner similar to that as is being done in an electronic whiteboard. The true multimedia content may include handwritten content and dynamic/multimedia data. The true multimedia content may either be shared among the participants, or may be provided by the participants to the convener. The true multimedia content may also be overlaid on a content shared through the e-canvas in real time among the participants.

Further, the devices and methods for touch screen based interactive media sharing over a network are described herein with reference to imparting education, for example, in a virtual classroom. In accordance with the method of the present subject matter, an instructor may deliver content on an e-canvas, which is shared with the students participating in a real time virtual environment and using touch screen based user devices. It would be understood that the session may also be a meeting of a group of people for sharing ideas, or may be an invigilated examination. Further, the real time virtual environment may include a session among the participants that can be implemented for conducting a training program, a conference, a workshop or a meeting, wherein an instructor or a trainer of the training program, or convener of the conference or a workshop, or the chairman of the meeting or a workshop or a conference. It would be appreciated that the session may include multiple participants along with one or more instructors or trainers or chairman or conveners.

In one implementation, a session in a real time virtual environment may be implemented for broadcasting, annotation, peer-learning, video-sketching, assessment and assimilation across networked Touch Screen User Devices (TSUDs). The touch screen based learning and interactive collaboration may include multiple TSUDs connected through a network, such as a Local Area Network (LAN) or a wireless network and communicating in a session.

In one implementation, the session may be an educational learning session having an instructor and one or more students. The instructor and the students may utilize one or more TSUDs to interactively communicate within the session. The TSUDs utilized by the instructor are hereinafter referred to as Master TSUDs (MTSUDs) and the TSUDs utilized by the students are hereinafter referred to as Client TSUDs (CTSUDs). In one implementation, the inputs of the MTSUD may be projected onto the wall or screen by using a projector in a closed room setting, such as an enclosed classroom so that the participants can directly view the input provided on shared e-canvas of the MTSUD. In another implementation, the inputs provided by the instructor on the MTSUD may be directly streamed on to the CTSUD of the participant and can be viewed by them instantly in real time.

Further, each participant may also be provided with a dedicated access to the MTSUD on his own CTSUD. In one implementation, the instructor may provide primary media content to all the participants on their CTSUDs. The primary media content may include static media content, such as pre-prepared text documents, PDF documents, presentations, chapters of e-books, scanned copy of physical material, video content, and inputs provided by the instructor on the e-canvas, including handwritten descriptions, annotations, graphical inputs, markup points, and the like.

In another implementation, upon receiving the primary media content from the MTSUD, each participant may overlay secondary media content on the primary media content to generate edited media content. The secondary media content may be a true multimedia content including a first handwritten content, such as annotation like personal note, underlined text, and scribbling against a particular section of the primary media content provided through touch screen; and first multimedia data, such as videos, flash content, PDF links, and audio content. Further, the primary media may also be provided to the participant in an editable format, for example, a PDF document may be converted such that it may be edited by the participant.

Further, in one implementation, apart from annotations and hand written content on general primary media, such as presentations and PDF documents; annotations and hand written content may also be provided on a video content. Different frames of the video content may be overlaid with secondary media, such as the hand written description and annotations. In said implementation, the hand written descriptions and annotations may be provided to the participants of the session in real time.

The participants may also annotate on the primary media content by utilizing secondary media content in the form of additional layer of notes on previously existing content on the TSUD. The previously existing layer of the primary media content, such as a Microsoft PowerPoint slide can be superimposed with another layer of handwritten notes by the participant in order to add his/her notes on top of the already prepared material using the touch gesture on the TSUD. Further, the participant may utilize various functionalities for customization of the provided inputs. For example, the participant may select the thickness and color of the line while drawing, and options to draw some standard shapes such as circles, squares, triangles etc. through drawing toolbar. The ability to erase/remove the secondary media content entered instantly or later on using delete/erase option may also be provided.

In yet another implementation, the participants may also write their own notes along with certain annotations to generate true multimedia on an e-canvas of their CTSUD. These notes may be independent of the primary media content and may be used by the participants for personal use. As described before, the e-canvas can be understood as a whiteboard on which participants may provide inputs through touch gestures. These inputs may include free style writing either through touch of hand or by the use of stylus. Further, the user of the TSUD may also embed multimedia content along with the freestyle inputs to the notes to make a true multimedia content on the e-canvas.

In one implementation, the edited content and the e-canvas of the participant may be shared with the instructor through the CTSUDs to the MTSUD. The sharing may occur in real time where the instructor may view the edited content, the notes, or both of each participant or a group of desired participants. Further, the instructor may also project the edited content provided by a participant, the e-canvas of a participant, or both on a display which can be viewed by all the participants. Similarly, the instructor may also share the edited content provided by a participant, the e-canvas of a participant, or both with the CTSUDs of all the participants in real time. This may provide a unique and intuitive learning experience for the participants including an instructor. It would be appreciated by those skilled in the art that the receivers of either the edited content or the e-canvas content of other users may further edit the content according to their own wish.

For example, a student may add a question in the form of a note to a presentation slide provided by an instructor. This may include streaming of the primary media content, the presentation slide to the student and the student further providing secondary content to the primary content in the form of the note to generate the edited content. The instructor may receive the edited content in real time while the student is providing the note. In such a scenario, the instructor may respond to the question by either writing on the e-canvas of the MTSUD which is shared with the participants in real time, or may respond by providing the answer on the edited content itself through inputs on the touch screen in the form of free style writing.

Further, an inter-participant communication may also occur through the various TSUDs. The inter-participant communication may include communication among the participants and the instructor and communication between one or more participants. The inter-participant communication may not only include real time display of the edited media content and the e-canvas of a TSUD on to the other TSUDs, but may also include exchange of anonymous or onymous messages. Through such messages, the participants may interact with the instructor and the other participants to share their doubts and queries. The participants may also chat with each other though inter-participant communication. In one implementation, the message may include one or more of second handwritten content provided through the touch screen and second multimedia data.

In another implementation of the present subject matter, the described systems may provide methods to enable peer learning in an interactive manner. If the instructor of the session wishes to communicate or share something instantly with the rest of the participants, the instructor may project the edited contend or the e-canvas of one or more of the CTSUDs of the participants onto a screen. In said implementation, the instructor may also combine the e-canvas of one or more participants to the e-canvas of his MTSUD such that the combined e-canvas is streamed to all the participants in real time onto their CTSUDs. This may ensure that participants learn from each other and ideas of one participant are shared with other participants seamlessly with almost no hassle.

Similarly, a participant may also share their e-canvas along with their written content on the screen with the entire class. For this purpose, the participant may either broadcast the content to the entire class, or may send a request to the instructor to get it broadcasted to all the participants in the session. The instructor may also provide a common e-canvas to all the participants where the e-canvas is synchronously common for all the participants and also shared with the participants in real time. This may be utilized for common and synchronous editing by the participants. Here participants may share the e-canvas from the comfort of their seats either in a live or a remote classroom, precluding the need for each participant to walk to the board. This may be useful for collective brainstorming in a classroom or a corporate meeting room. Further, the instructor may also project the common e-canvas for all the participants to view the ideas represented on a larger screen.

In still another implementation, the TSUDs may also facilitate the instructor and participants to create animated motion of the objects to further explicate a concept that is not so easily understood by the participants and also to make the session more interesting and lively. Animation can be created even by not so tech savvy instructors in a matter of seconds. Instructors and participants may create animated output by drawing sequential figures of an object in motion on the e-canvas. The instructor or the participant may define a time interval during which such sequential frames of a diagram are to be played. Thus, an animation can be created that plays as an animated video with the functionality of pausing, rewinding or fast-forwarding. In another implementation, the instructor can select the number of frames and then draw simple sketches for each frame. Each frame may then be displayed in quick succession and may be looped indefinitely to give the impression of an animation.

In one implementation, the content provided by the instructor may also be recorded in the same order in which it was provided. Furthermore, the audio of the instructor's teachings may also be recorded. The recorded content may either be saved on individual TSUDs or may be saved on a central server providing connectivity to the TSUDs. Thus, the recorded content can be re-played by the users whenever and wherever the pre-recorded session may be displayed step by step in the same order as they were recorded along with the sound recording of the speech that was delivered by the instructor. Replay may also help students who missed classes in learning.

Further, the TSUDs may also facilitate creation of tests and quizzes. The tests may include timed multiple-choice questions to test the understanding of the students/participants. This may also be used to garner the opinion of each participant (akin to a survey). Once the participants' key in their choices, the distribution of participants response may be provided to the instructor. These responses can also be drilled down to the participant level, enabling the instructor to tailor the lecture based on responses garnered. In addition to classroom quizzes, more elaborate, subjective/essay-type assignments can also be administered in the classroom in a paperless manner, exploiting the full potential of the writing capabilities of the TSUDs described earlier. Further, these in-classroom quizzes can be analyzed for insights and can provide an indicator of student's performance. That is, the instructor may spot a slow learner and provide additional attention onto him for his better learning and development process.

TSUDs may further be utilized to administer full-scale closed-book/open-book exams in a paperless manner. Students may assemble in an examination hall, as they would when they write conventional examinations. However, instead of using pen and paper, the students may be provided with, or may bring along with, the CTSUDs. In such a scenario, the CTSUDs may not be allowed to communicate with other participants or broadcast their e-canvas or content. Students may be provided with only questions through a MTSUD, pertaining to the examination being administered. Students may provide answers to the questions through the touch screens of the CTSUDs using either a stylus, or touch gesture through hands. Depending on the type of examination being administered (open-book/closed-book, etc.), certain content of the classroom sessions can also be selectively made available. Conventional online assessments being administered worldwide are either fully objective/multiple-choice question based assessments or at best a typed answer to an essay-type question. The annotation utilities of the present subject matter described above mimics a rich pen-and-paper type response, a combination of free-hand sketches with the help of digital tools and free-hand writing, with no restrictions on the part of the examinee. After administering the timed examination, the participants' response can be provided to the instructors where each response would be graded. The instructor may grade these examinations offline and may hand them back to the students, in a paperless and an efficient fashion.

Thus, the described systems and methods facilitate interactive media sharing over a network. The described TSUDs may be utilized for touch-screen based learning and collaboration. The described methods may further be utilized for broadcasting, annotation, peer-learning, video-sketching, assessment and assimilation across the networked TSUDs. Various participants independently can engage in a learning activity through broadcasting while other participants can benefit from some exceptional solution provided by other students. This may provide a unique and intuitive learning experience for the participants including an instructor. Furthermore, the in sync real time streaming of the instructor's content or the e-canvas provides convenient and effective way to call participants attention. Participant may not be required to divert his/her attention on replicating what is written on the board and also, he/she can view the content appear instantly on his/her TSUD.

It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

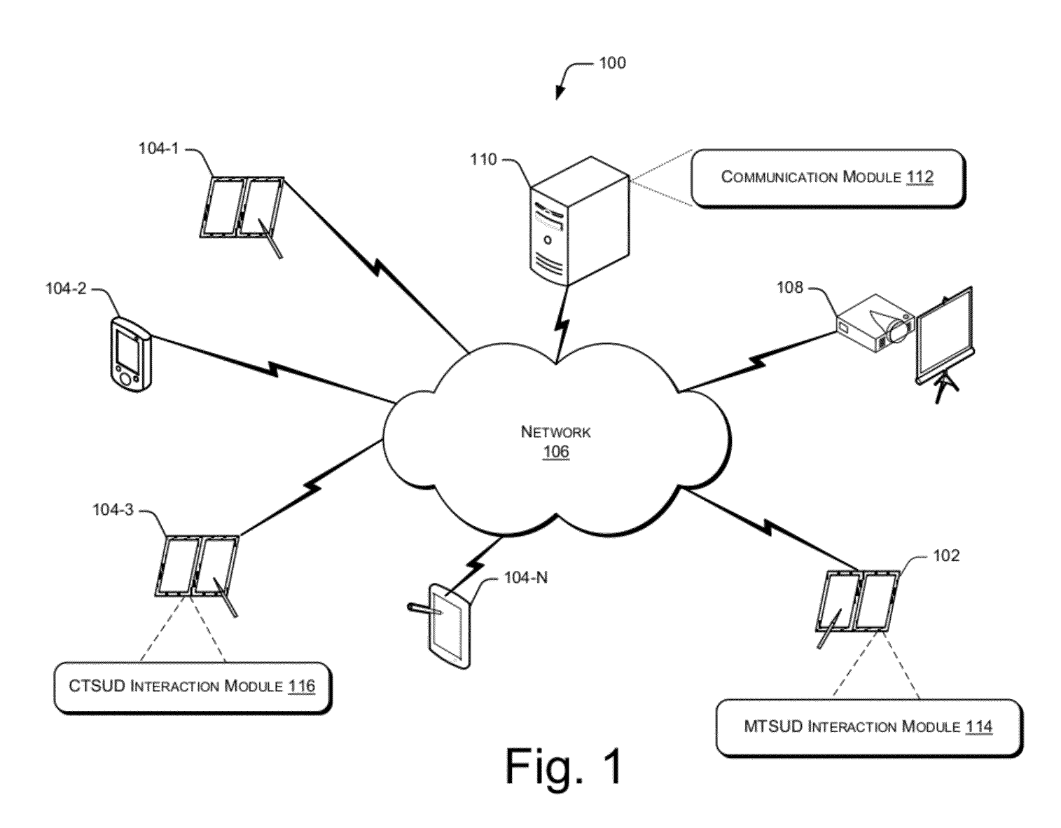

The manner in which the systems and methods of interactive media sharing in a real time virtual environment over a communication network shall be implemented has been explained in details with respect to the FIGS. 1-13. While aspects of described systems and methods for interactive media sharing over a communication network can be implemented in any number of different computing systems, transmission environments, and/or configurations, the embodiments are described in the context of the following exemplary system(s).

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” and “coupled” is used throughout for clarity of the description and can include either a direct connection or an indirect connection.

FIG. 1 illustrates a networking environment 100 for touch screen based interactive media sharing, according to an embodiment of the present subject matter. The networking environment 100 includes one or more touch screen user devices (TSUDs). The TSUDs may include a master TSUD (MTSUD) 102, along with multiple client TSUDs (CTSUDs) 104-1, 104-2, and 102-N (collectively referred to as CTUDs 104, and individually referred to as CTUD 104 hereinafter). The TSUDs may communicate with each other through a network 106. The TSUDs may be used by different participants to communicate with each other and establish session between different participants. The participants may be the students in an educational environment or the meeting participants in a business meeting environment. Each one of such participants may have an independent TSUD. Further, in one implementation, the participant utilizing the MTSUD 102 may be an instructor and the participants utilizing the CTSUDs 104 may be students. The TSUDs may include any communication device with a touch screen including, but not limited to, desktop computers, hand-held devices, laptops or other portable computers, network computers, and mobile phones. Each of the TSUDs may work on a communication protocol as defined by the network 106 to which the TSUD is communicatively coupled.

Further, the touch-screen may be an electronic visual display that can detect the presence and location of a touch within the display area. The term input through a touch-screen may refer to touching the display of the TSUD with a finger, hand or any other passive objects, such as a stylus. The stylus may be a small writing tool used for any form of marking or shaping. The individual TSUD with every participant can be either a single touch-screen device, having only a single display screen or a dual touch-screen device, having two display screens that are adjacent to each other and can be folded like a notebook. In one embodiment, the TSUDs can be embedded on the top surface of the table and in another embodiment; the TSUDs can be mounted vertically on a wall or a vertical surface. The individual TSUDs may be designed to handle a single touch input by a finger or a stylus, two touch inputs with two fingers or multi-touch inputs with more than two fingers, deploying any of the technologies that exist in the art.

The network 106 may be a wireless network, wired network, or a combination thereof. The connection can in turn be implemented as one of the different types of networks, such as intranet, telecom network, electrical network, local area network (LAN), wide area network (WAN), Virtual Private Network (VPN), internetwork, Global Area Network (GAN), the Internet, and such. The connection may either be a dedicated connection or a shared connection, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the connection may include a variety of network devices, including routers, bridges, servers, computing devices, storage devices. Further, the network 106 may include any medium, usually referred to as a channel, such as air, a wire, a waveguide, an optical fiber, or a wireless link, and exchanges data between the MTSUD 102 and one or more CTSUDs 104.

In one implementation, the MTSUD 102 of the instructor may be projected onto a wall or screen by using a projector 108 so that the participants can directly view the input entered on the MTSUD 102 on the screen. In another embodiment, wherein the participants are remotely located, the input entered on the MTSUD 102 of the instructor may directly be transmitted on the touch screen of the CTSUD 104. In one implementation, the communication between the MTSUD 102 and the CTSUDs 104 may be facilitated by a media server 110. The media server 110 may include any server known in the art, including a main frame server, a blade server, a super computer, a cloud server, and the like.

The media server 110 may include a communication module 112, which may interact with the interaction modules of the MTSUD 102 and CTSUD 104. In said implementation, the MTSUD 102 may include a MTSUD interaction module 114 and each CTSUD 104 may include a CTSUD interaction module 116. The communication module 112 through communication with the MTSUD interaction module 114 may provide the media content of the MTSUD 102 to the CTSUD interaction module 116 in real time. The CTSUD interaction module 116 may provide the media content received from the communication module 112 of the media server 110 to the touch screen of the CTSUD 104. Further, the communication module 112 of the media server 110 may also provide the content of the MTSUD 102 for projection on the screen/wall through the projector 108.

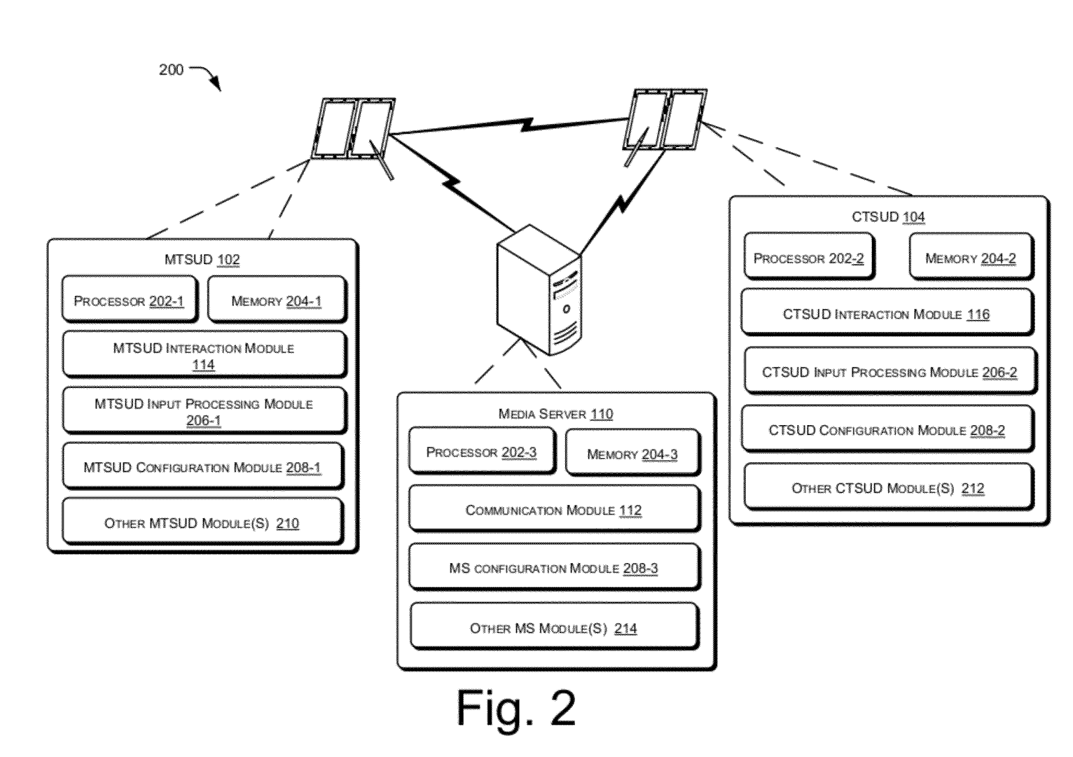

FIG. 2 illustrates various components of the MTSUD 102, CTSUD 104 and the media server 110, according to an embodiment of the present subject matter. In one implementation, the MTSUD 102, the CTSUD 104 and the media server 110 may each include a processor that may be referred to as a MTSUD processor 202-1, a CTSUD processor 202-2 and a media server processor 202-3, respectively. The processors 202-1, 202-2 and 202-3 are collectively referred to as the processors 202 hereinafter.

The processor(s) 202 may include microprocessors, microcomputers, microcontrollers, digital signal processors, central processing units, state machines, logic circuitries and/or any other devices that manipulate signals and data based on operational instructions. The processor(s) 202 can be a single processing unit or a number of units, all of which could also include multiple computing units. Among other capabilities, the processor(s) 202 are configured to fetch and execute computer-readable instructions stored in one or more computer readable mediums.

Functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The computer readable medium may include any computer-readable medium known in the art including, for example, volatile memory, such as random access memory (RAM) and/or non-volatile memory, such as flash.

The MTSUD 102, CTSUD 104 and the media server 110 may further include one or more memory components, referred to as memory 204-1, 204-2 and 204-3, respectively. The memory 204-1, 204-2 and 204-3 are collectively referred to as memories 204 hereinafter. The memories 204 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the MTSUD 102 and the CTSUD 104 may include a MTSUD interaction module 114 and a CTSUD interaction module 116, respectively. The MTSUD interaction module 114 and a CTSUD interaction module 116 may collectively be referred to as interaction modules 115 and may be understood as any conventional interaction module, such as a transreceiver that enables communication and interaction between the TSUDs.

The MTSUD 102 further includes, amongst other things, various modules, in accordance with one embodiment of the subject matter. The MTSUD 102 may include a MTSUD input processing module 206-1, MTSUD configuration module 208-1, and other MTSUD modules 210. Similarly, the CTSUD 104 may further include, among other things, various modules, such as a CTSUD input processing module 206-2, CTSUD configuration module 208-2, and other CTSUD modules 212. Further, the media server 110 may also include a media server (MS) configuration module 208-3, and other MS modules 214.

The various modules described herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Further the functionalities of various modules may be embodied directly in hardware, in a software module executed by a processor, or in a combination of the two.

In one implementation, the communication module 112 of the media server 110 may facilitate the real time synchronous communication between the MTSUD 102 and the CTSUD 104. The media content provided by the instructor on the MTSUD 102 may be streamed to the CTSUD 104 in real time. In one implementation, the media content may include media content, such as text documents, PDF documents, presentations, chapters of e-book, scanned copy of physical material, question papers, quizzes, and inputs provided by the instructor on the e-canvas including handwritten descriptions, annotations, graphical inputs, and markup points. Further the media content may also include dynamic media content such as flask files, video files, and audio files. Further, the interaction modules 115 may also broadcast the media content from the CTUDs 104 to other TSUDs including the MTSUD 102.

The MTSUD input processing module 206-1 of the MTSUD 102 and the CTSUD input processing module 206-2 of the CTSUD 104 are collectively referred to as input processing modules 206, may be configured to receive inputs from the participants through the touch screen of the TSUDs. In one implementation, the inputs provided by the participants are graphical inputs provided though hand gestures. The input processing modules 206 may be configured to analyze and identify the inputs provided by the participants through the touch gestures.

The MTSUD configuration module 208-1, the CTSUD configuration module 208-2, and the MS configuration module 208-3, collectively referred to as the configuration module 208 hereinafter, may be configured to provide different functionalities to different TSUDs. The MS configuration module 208-3 may configure the functionalities available to the MTSUD 102 and the CTSUD 104 by configuring the MTSUD configuration module 208-1 and the CTSUD configuration module 208-2. In one implementation, the MS configuration module 208-3 may configure the MTSUD configuration module 208-1 to receive inputs from multiple participants in real time. Similarly, the CTSUD configuration module 208-2 may be configured by the MS configuration module 208-3 to provide the inputs provided by the participants to the MTSUD 102.

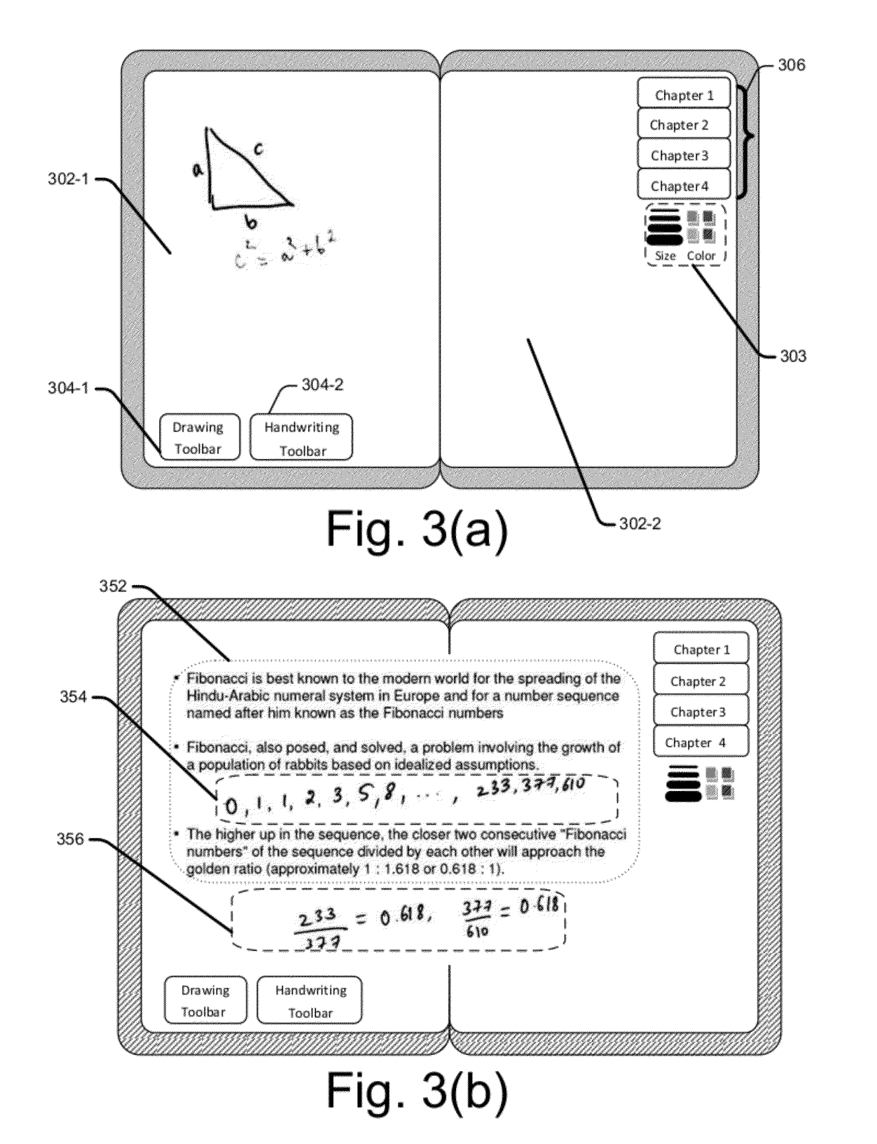

FIGS. 3(a) and 3(b) illustrate an e-canvas of the TSUD, in accordance with an implementation of the present subject matter. The TSUD depicted in the FIGS. 3(a) and 3(b) is a foldable TSUD with two touch screen portions, one on the left 302-1 and another on the right 302-2, acting as e-canvas. The figures also illustrate various annotation functionalities of the TSUD, in accordance with one embodiment of the present subject matter. The TSUD provides various features for better annotation and understanding of subject matter during a remote classroom session of a meeting/seminar. The TSUD provides the instructor/participant with the facility to freely write down notes or scribble using either a stylus or human touch gesture on the touch-screen area of the TSUD.

The user interface of the TSUD provides various functionalities for customization of the input entered by the user. For example, a user can select the thickness of the line while drawing using the line thickness menu 303 provided on the user interface. Similarly the color of the lines or any input entered on the display area 303 can also be changed by selecting a preferred color through the color palette on the user interface. Options are provided to draw some standard shapes such as circles, squares, triangles etc. through drawing toolbar 304-1. The input processing modules 206 may facilitate the handwriting toolbar 304-2 to recognize the handwriting of the user and automatically converts pen scribbles entered by the user on the display area 302-1 into digital text that can be read easily later on. One can also freely insert gaps in the writing area (not shown). The content entered in the display area can be organized under various heading/subheadings such as buttons 306 as shown in the figure. The TSUD also provides the ability to erase the content entered in the display area 302-1 and 302-2, instantly or later on using a delete/erase option (not shown).

FIG. 3(b) shows a the display area of the TSUD illustrating annotation of an additional layer of notes and secondary media content on a primary media content, in accordance with an embodiment of the present subject matter. In an example, primary media content may be a presentation slide, for example, Microsoft PowerPoint slide 352. The slide may be provided by the instructor through the MTSUD 102 which may be provided to each CTSUD 104. Each participant may overlay secondary media content on the slide in order to add his/her notes on top of the already received static primary media content. Instructor/participant can add an additional layer of notes, such as first handwritten content 354 and 356, using either a stylus or through touch gesture on such already existing layer of the primary media content to generate edited media content, as shown in the FIG. 3(b).

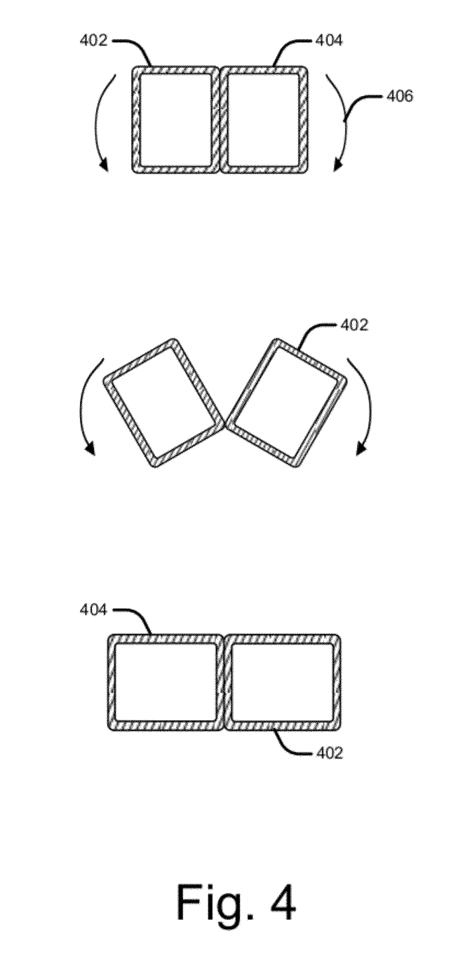

FIG. 4 illustrates a swiveling and change of orientation of dual TSUD, in accordance with the implementation of the present subject matter. In one embodiment, the two display screens 402 and 404 of the dual TSUD can swivel as indicated by arrow 406, around one corner (as shown in the figure) and change its page orientation. Page orientation is the way in which a rectangular display screen is oriented for normal viewing. The two most common types of orientation are portrait and landscape depending upon the orientation, that is, vertically or horizontally. Portrait refers to orientating the display screen such that its height is greater than the width of the screen and landscape means orientating the canvas such that its width is greater than the height of the page. In one particular embodiment of the dual TSUD, the two display screens can swivel 406, the attached screens can be turned about a link, pivot, or other fastening means and orientation is changed from portrait to landscape by turning them about vertical axis.

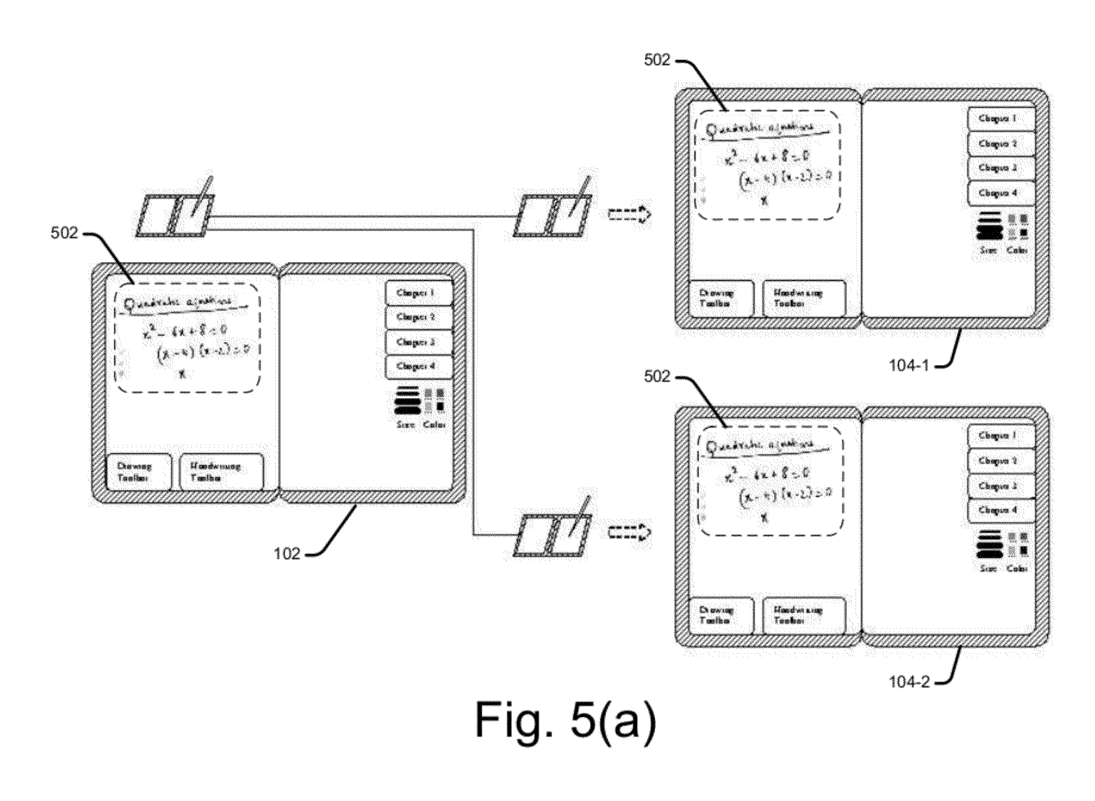

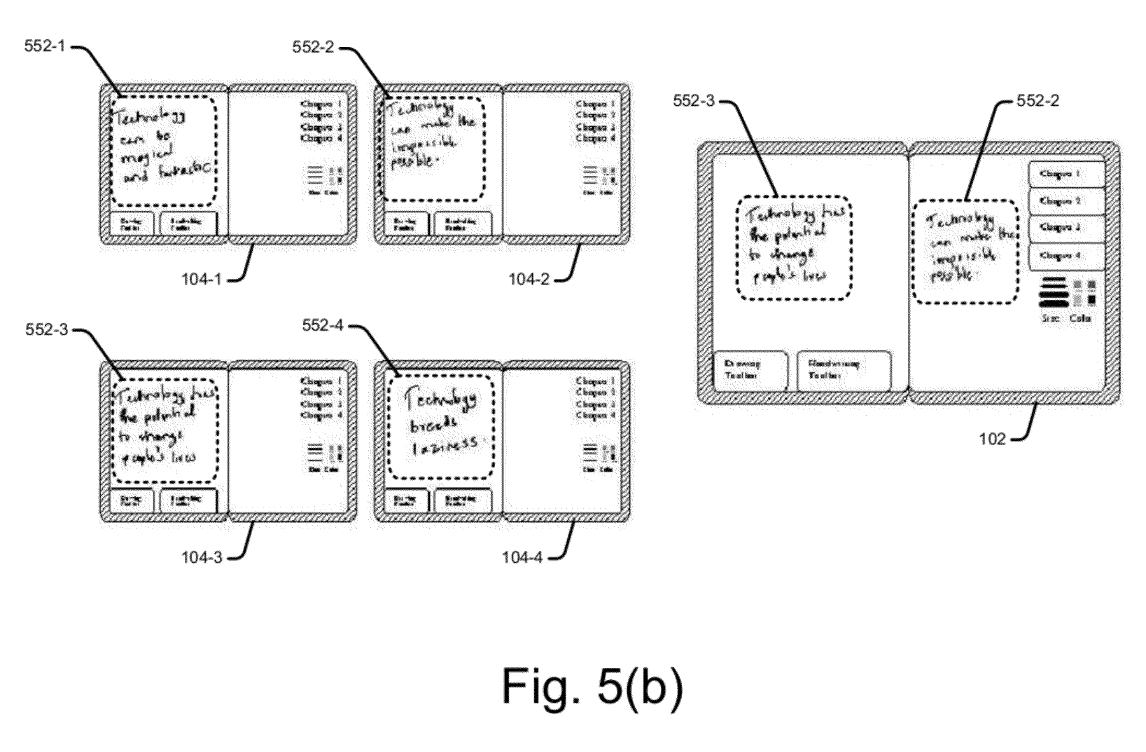

FIG. 5(a) illustrates the display area of the TSUD illustrating the broadcasting utility in real time, in accordance with an implementation of the present subject matter. In one implementation, the MTSUD interaction module 114 of the MTSUD 102 may instantly broadcast the inputs 502 provided by the instructor on the MTSUD 102 to all other networked CTSUDs, such as the 104-1, and 104-2, during a session. In one implementation, the communication module 112 of the media server 110 may communicate between the MTSUD 102 and the CTSUDs 104.

FIG. 5(b) illustrates the display area of the MTSUD 102 displaying inputs from CTSUDs 104, in accordance with one embodiment of the present subject matter. In one implementation, in case the instructor wishes to communicate or share the contents from a participant CTSUDs with the rest of the participants, the instructor may bring up the display areas of one or more of the networked participant CTSUD 104-1, 104-2, 104-3, and 104-4 onto the display area of the MTSUD 102. This may be done be selecting the participants from the available participants by clicking through human gesture or a stylus on the touch screen of the MTSUD 102. This may help the participants to learn from each other. Similarly, in case a participant wants to share whatever is written on his display screen with the entire class, he can do so by sending it to the instructor and getting it broadcast to all the participants in the session.

In an example, the instructor may ask all the participants to comment individually on what they think about technology in one sentence. All participants may respond with their response 552-1, 552-2, 552-3, and 552-4 individually on the display area of their CTSUDs 104. In said example, the instructor may choose the responses 552-2 and 552-3 of the two participants 104-2 and 104-3 respectively and display them on his/her MTSUD 102 so that all the participants can view what the two selected participants have written on their display screens. The sharing of media content in real time is useful especially when various participants independently engage in a learning activity (e.g. solving a mathematical problem) and other participants can benefit from some exceptional solution provided by other participants that is brought up on an instructor's display screen.

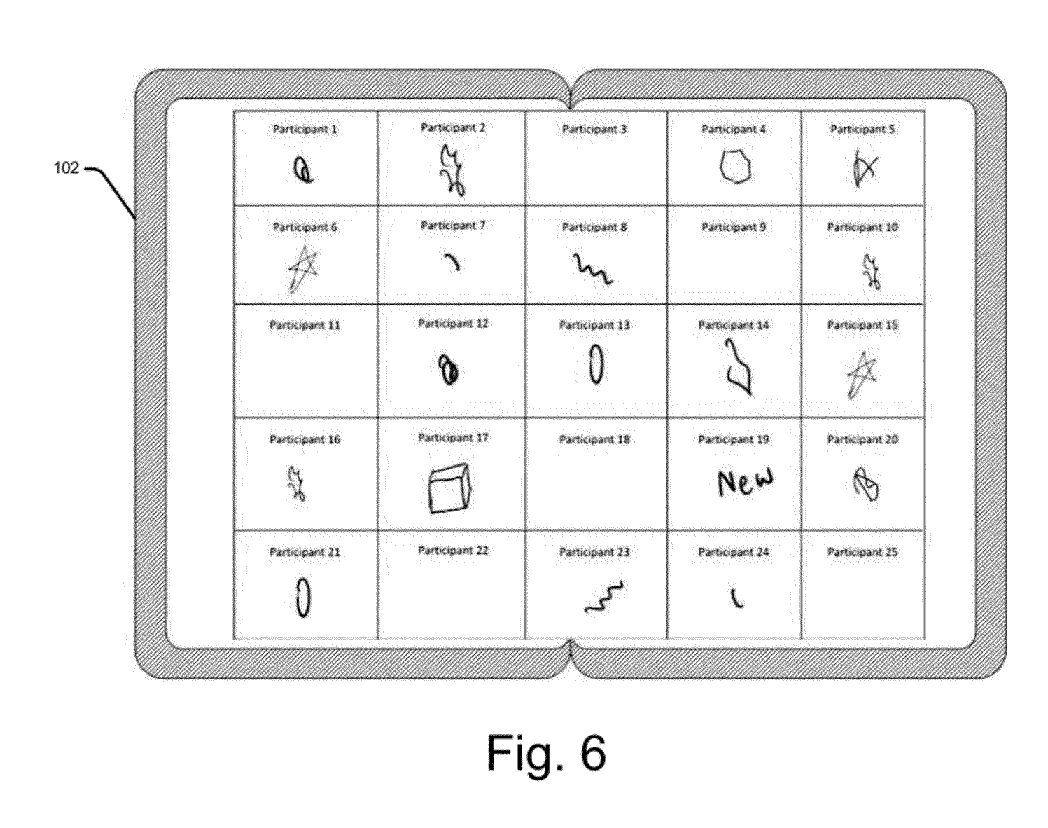

FIG. 6 depicts the display area of the MTSUD 102 illustrating the sharing of an instructor's display area equally among all the participants, in accordance with an implementation of the present subject matter. In said implementation, an instructor may throw open the display area into equal sections for synchronous editing by the participants wherein each of the section is reserved for one participant. The screen may be scrolled down in case the number of participants is large and the display area of the MTSUD 102 falls short to fit the sections of all the participants. Every participant may be provided with an equal share of the display screen for jotting and can simultaneously view other participants' entries instantly as they are being written.

To provide this functionality, the instructor may provide an instruction to the media server 110 through a touch gesture on the touch screen of the MTSUD 102. The input processing module 206-1 of the MTSUD 102 may interpret the input and provide the instruction to the media server 110. In such a scenario, the MS configuration module 208-3 may configure the e-canvas of the MTSUD 102 into various sections wherein each section is accessible by one CTSUD 104. In an implementation, each CTSUD 104 may have a unique TSUD ID based on which the distribution and mapping of each e-canvas may be done. The divided e-canvas of the MTSUD 102 may be provided dynamically to each of the students as they provide inputs on their respective touch screen. In one implementation, each stroke is recorded and maintained by the media server 110 from which all the connected CTSUDs 104 receive the input.

Each of the networked participant CTSUD 104 may run a timer that may get triggered periodically (say after every 1 second). When the timer is triggered, firstly, input from every participant's CTSUD 104 is transmitted to the media server 110 which comprises incremental strokes painted since last update. Secondly, since the update, the new painted strokes from the media server are also read. Strokes form both the recording and the CTSUD 104 are superimposed and transmitted to all connected CTSUDs 104. Thus all the connected CTSUDs 104 are updated with the latest strokes.

The TSUDs described herein can be used to enhance the efficiency and effectiveness of teaching methodologies as compared to traditional classroom. For example, an English teacher who has been trying to ensure that his students use good English in the written form including the correct grammar and a wide vocabulary, both of which are difficult to build in traditional classroom, may utilize the described TSUDs. The instructor may give effective exercises and spend 5 min on every task on practical exercises rather than readout new words which can be quite overwhelming for the students. Instructor can throw open the display screen for free writing where every student gets a share of the virtual whiteboard to write the one word that comes to him or her.

The instructor, within a span of few seconds, can view every student's response and can correct the spelling instantly in the classroom by directly inscribing his notes over the student's replies. Since the participants can see what others have written in real time, they can learn from an exceptional answer from a particular participant or tips to improve word usage. The students who are hesitant to approach teacher or the backbenchers who are challenged with spellings can learn correct spellings without being pointed at. The system also improves the quality of education among the participants since the instructor can adjudge the level of knowledge and understanding of the participants by their answers and can spend more time on tailoring the teaching methodologies based upon the weak areas of the participants. This utility may also be useful for collective brainstorming in a classroom or a corporate meeting room. In one implementation, the communication module 112 of the media server 110 may provide the responses of the students provided to the CTSUDs 104 through touch screen.

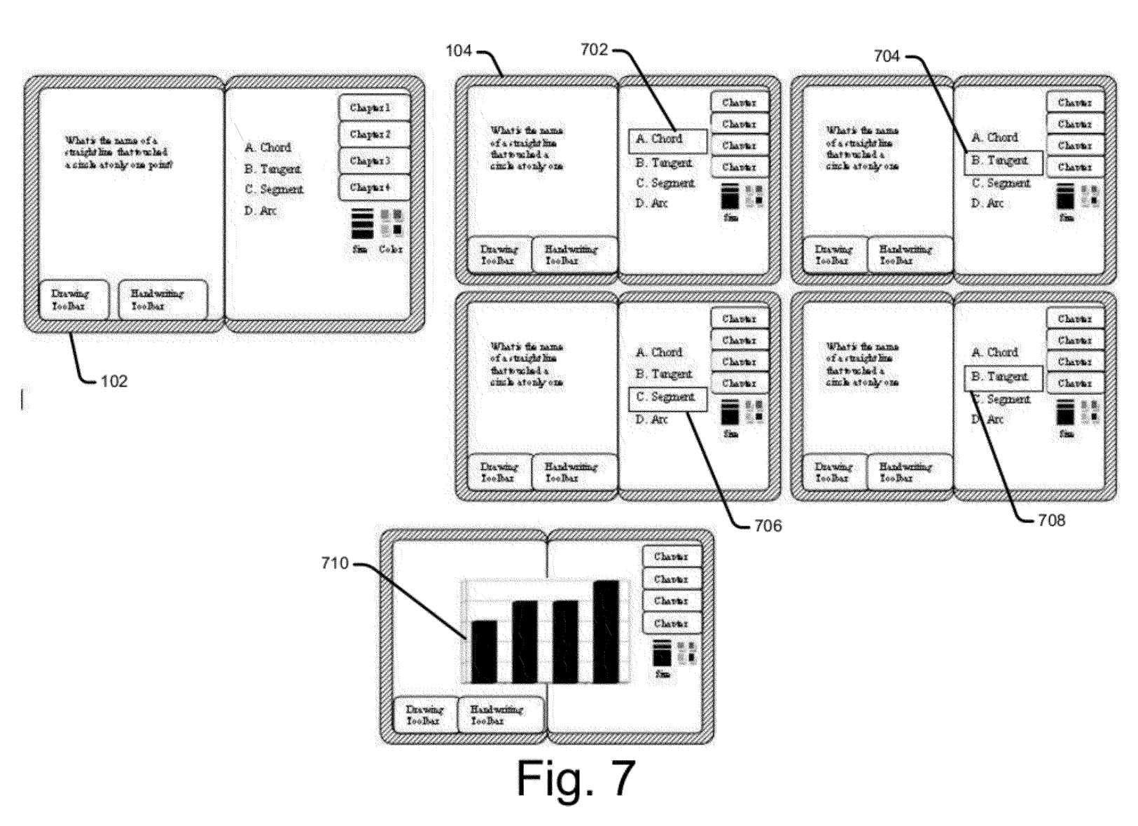

FIG. 7 depicts the display area of the MTSUD 102 and the CTSUD 104, illustrating a scenario where an instructor provides a multiple choice quiz to the students to respond, in accordance with an implementation of the present subject matter. The students may respond with their individual answers. The distribution of participant responses can be instantly viewed by the instructor on the MTSUD 102. The instructor may be provided with a flexibility of creating timed multiple-choice questions also to test the understanding of the participants. In the illustrated example, an instructor has created a multiple-choice question and has broadcasted it to all the students through the MTSUD 102. The students, through their CTSUDs 104, may respond with their individual answers 702, 704, 706, and 708 respectively. The students who usually have a limited attention span can easily be engaged in learning process by answering quizzes. Generally shy students can answer questions without feeling awkward about speaking out. This facility can also be used to garner the opinion of each participant for the purpose of survey and analysis. Once the participants' key in their choices, the media server, apart form displaying the response of each individual student, may also instantly provide the distribution of student responses 710 on the MTSUD 102 of the instructor.

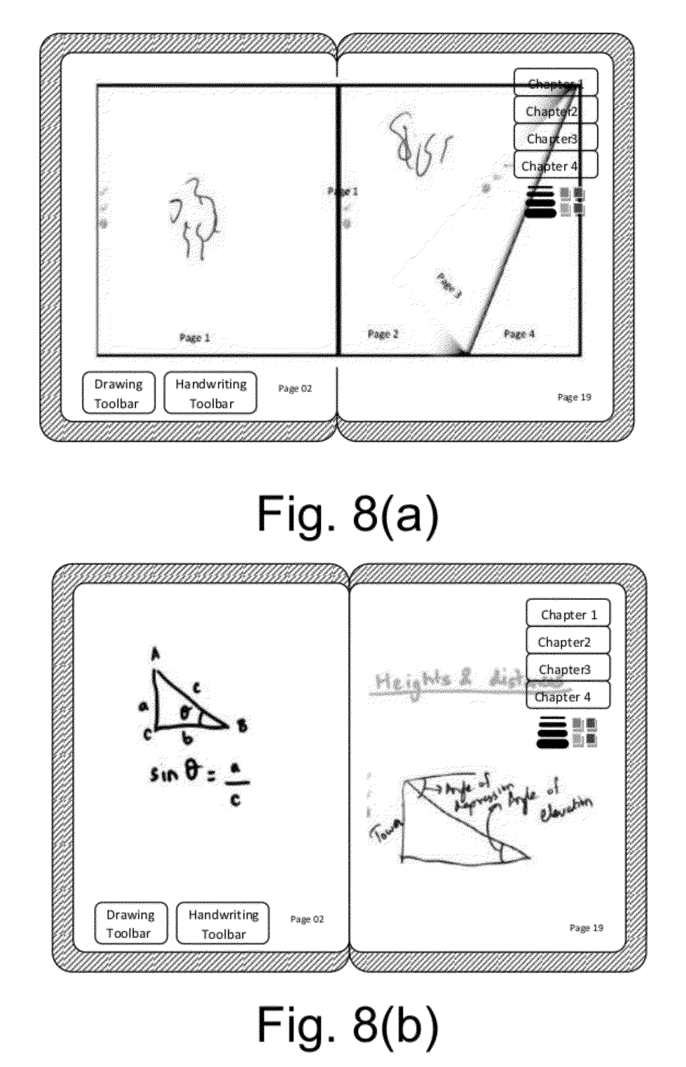

FIGS. 8(a) and 8(b) depict the display area of the TSUD, illustrating the turning of pages and also viewing of discontinuous pages, in accordance with one implementation of the present subject matter. The TSUD displays all the data on unique digital paper (UDP) with look and feel of a real paper and also provides unlimited number of pages in each of such device. Further, the UDP also provides discontinuous page viewing of a document at any time instance. The pages can be turned in the similar manner as is done with real paper as shown in the figure. Moreover, the pages can be flipped as well from one page to any other page saved earlier. Two pages can also be viewed at the same time including pages that may be discontinuous, as shown in the figure. In addition, in multi-touch embodiment of the touch screen, the user can flip the pages and fold adjacent pages (not shown), as can be done using a normal paper.

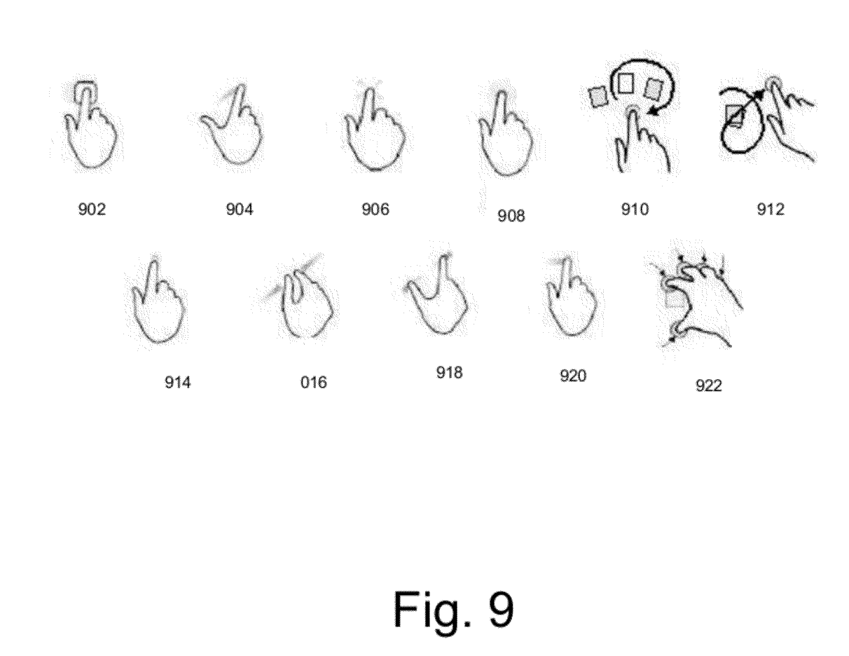

FIG. 9 depicts a schematic diagram illustrating the touch-screen gestures. The TSUDs may also recognize known multi-touch-screen gestures like drag item 902, flick finger 904, tap 906, tap and hold 908, lasso 910, lasso and cross 912, nudge 914, pinch 916, spread 918, slide finger 920, and scrunch 922 as shown in the figure etc., and several new touch-screen gestures unique to the requirements of the education and training industries.

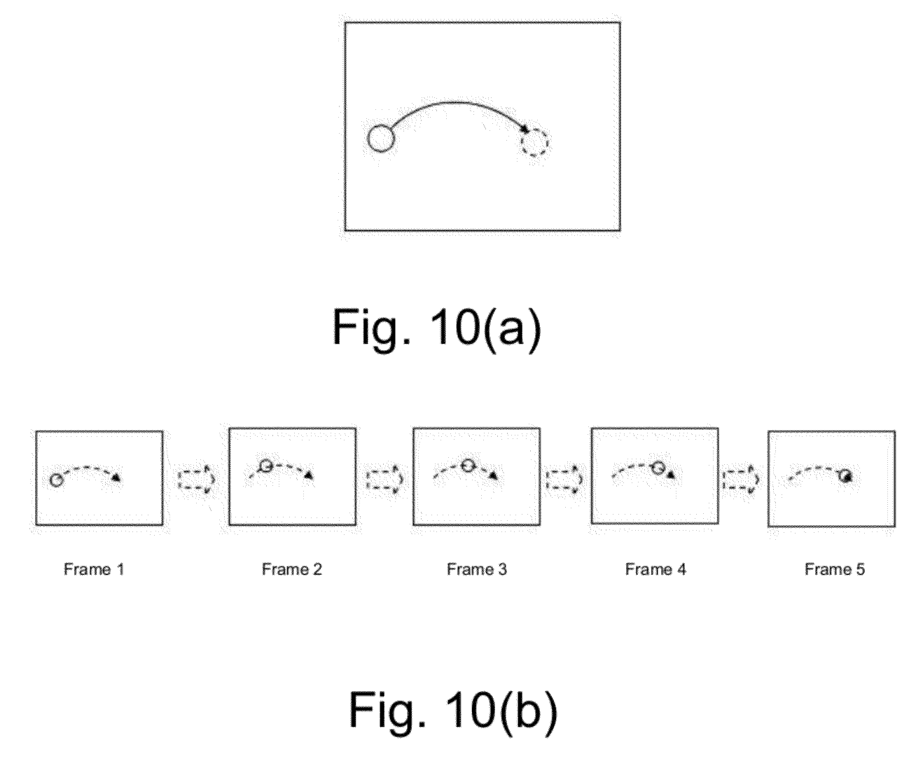

FIGS. 10(a) and 10(b) illustrate the method of drawing an animation utilizing the TSUDs described herein. FIG. 10 (a) depicts a diagram of the conventional method of depicting a projectile motion without the use of animation technique. Conventional methods for explaining motion/movement of certain objects are generally multimedia training material with preloaded animations/videos etc. Such study material is normally created by some third parties having skills of developing animations/video and the instructor can't create them while teaching in class. Moreover, the participants can not annotate on them for writing down their notes etc. For example, while explaining a projectile motion, a simple sketch is prepared on the board in order to predict an object in motion that shows the first position and the last position of the object in motion along a dotted line. Such illustration doesn't clearly describe the exact motion of a moving object effectively and is quite uninteresting for a user as well as has very low probability of getting registered in a user's mind.

FIG. 10(b) depicts the various frames presented on the e-canvas of the MTSUD for the instructor to create an animation of a projectile motion, in accordance with an embodiment of the present subject matter. The system provides various methodologies whereby a user can easily create animations through the options provided on the user interface of MTSUD 102. The MTSUD 102 may provide a method of instantly creating new animations depending upon instructor's need rather than rely only on preloaded content. The instructor may provide inputs to each frame by drawing the state of the object during the projectile motion. The animated output is generated as illustrated in set of frames, frame 1 to frame 5. The animation depicts the object's motion frame by frame, thus providing an animated output that plays only once or may loop infinitely to ease a students understanding.

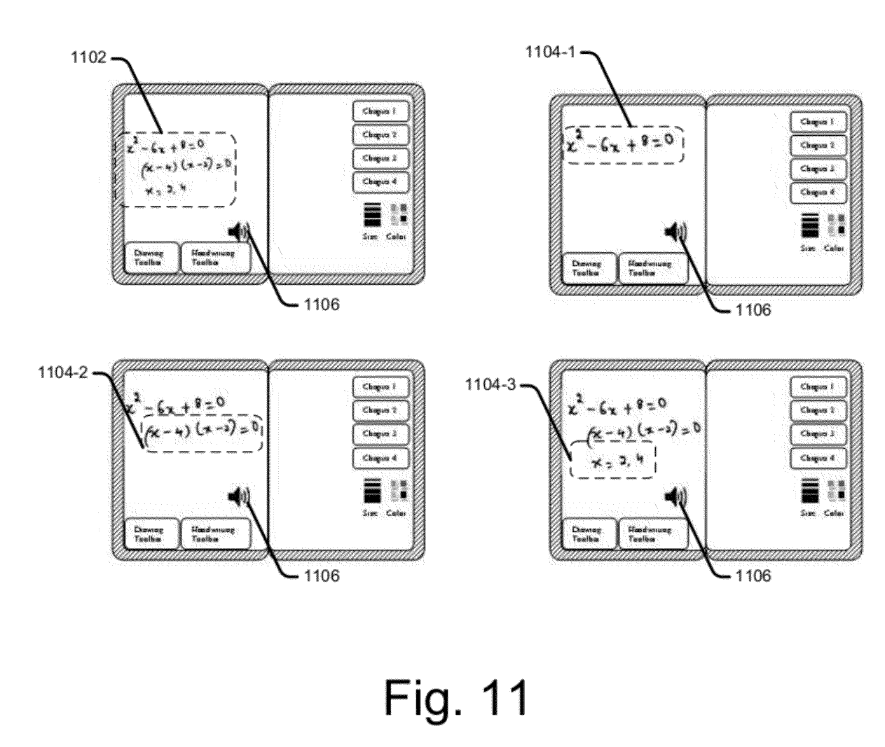

FIG. 11 depicts the display area of the TSUD illustrating the replay of a pre recorded session, in accordance with one embodiment of the invention. As described before, the media server 110 may save the content provided by the instructor and the participants after every pre-determined time interval. In one scenario, the media server 110 records the contents entered by the instructor in the same order in which they were entered along with the audio recording of the speech delivered while entering the content. This recorded content can be played by the user whenever he wants and the pre recorded session is displayed step by step in the same order as they were recorded along with the sound recording of the speech that was delivered by the instructor. In an illustrated figure, a three step equation 1102 is retrieved from prior classroom notes and replayed so that the equation 1102 can be explicated step-by-step as shown in 1104-1, 1104-2 and 1104-3 in the exact order in which it was explained while the material was delivered, along with the speech 1106 overlay of what was narrated by an instructor as each line was written. The note specific chatting can also be retrieved from the media server. The functionality provided by the media server 110 may provide a convenient medium to study after the session. Moreover, the slow learners can rewind and play all the activities during a session step by step along with speech overlay. Replay also helps students who missed classes for genuine reason and learn.

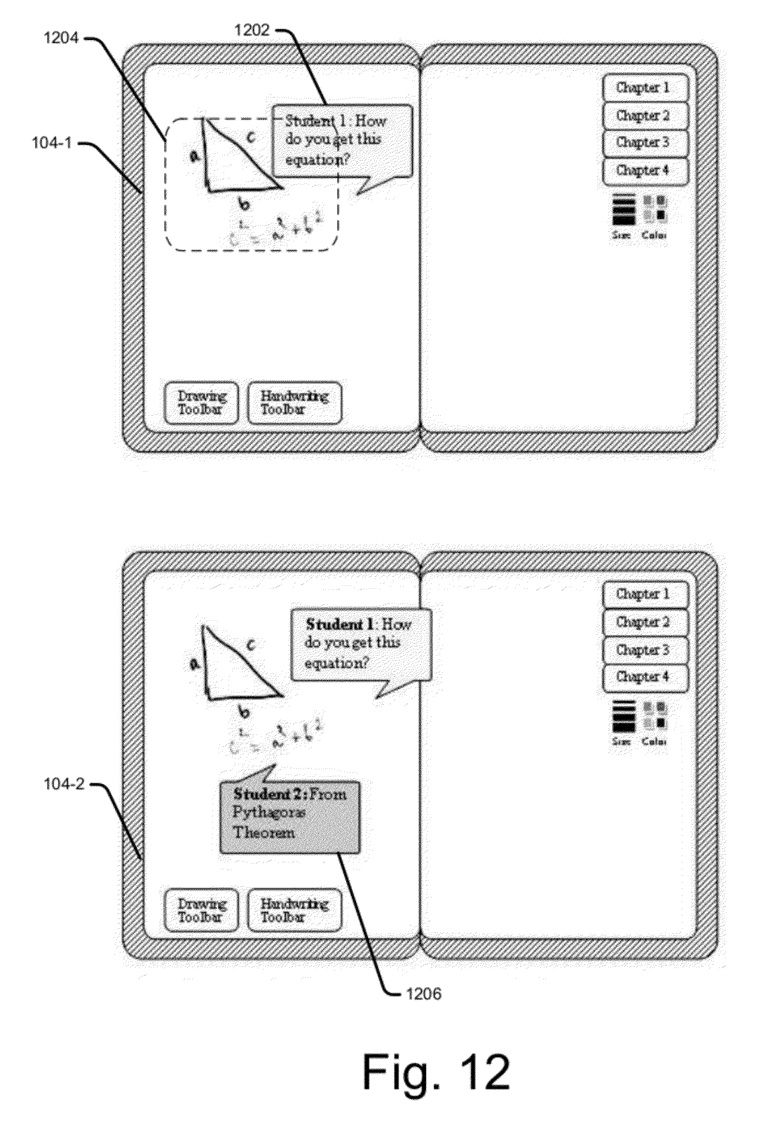

FIG. 12 depicts a display area of the TSUD illustrating the functionality of virtual combined learning, in accordance with an implementation of the present subject matter. Students can connect with their CTSUDs to other fellow students by touch of a button and discuss their doubts through a chat application for better understanding of the previous or current session. The instructor can also activate the chatting facility among the participants in order to enable participants chat with each other during a session. In an illustrated embodiment, the participants can exchange notes or ask questions in the context of their notes, objects or against the backdrop of particular notes objects, thus providing the ability to perform combined-study virtually.

In an example, a student utilizing the CTSUD 104-1 may ask a question 1202 referring specifically to particular notes or chapter content 1204 to another student utilizing the CTSUD 104-2. The message 1202 sent by a student may instantly appear onto the CTSUD 104-2 of the other student. When the student utilizing the CTSUD 104-2 replies to the message 1202 with his answer 1206, the same may appear instantly on display screen of the student utilizing the CTSUD 104-1. In a similar manner, a student may interact with the instructor in middle of a session through a silent electronic hand-raise or through a message as depicted by 1202 and 1206.

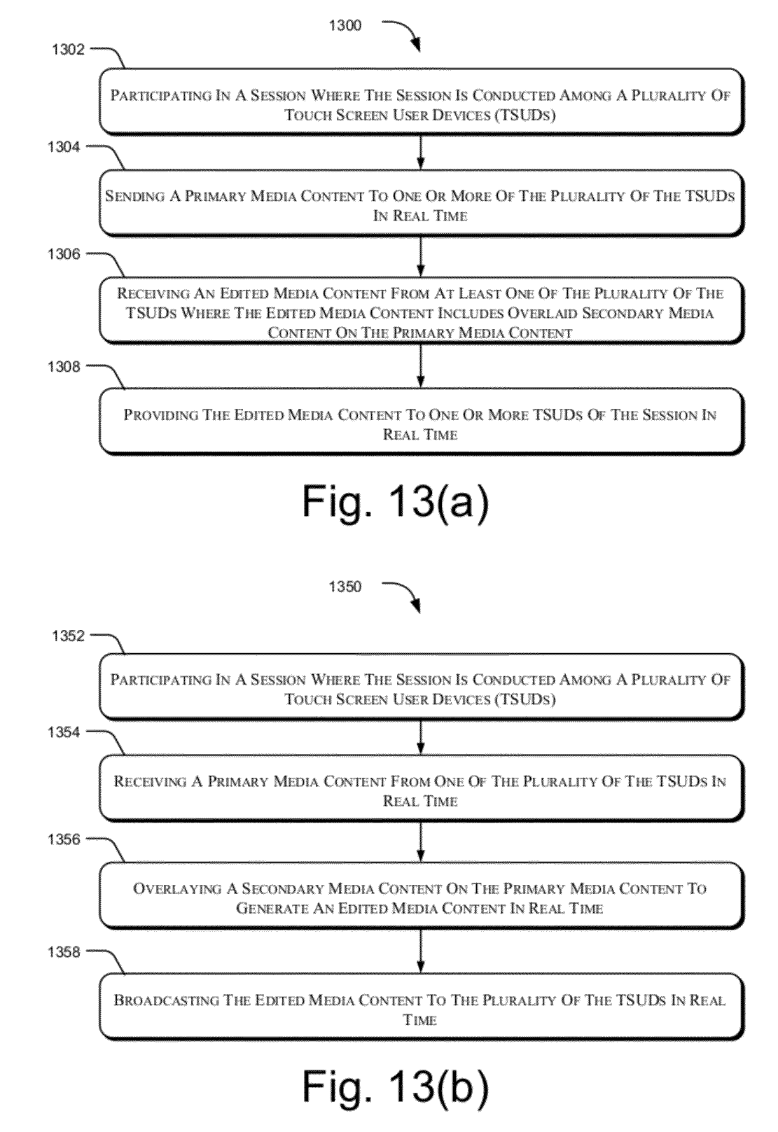

FIGS. 13(a) and 13(b) illustrate methods 1300 and 1350 for interactive media sharing, in accordance with an implementation of the present subject matter. According to an aspect, the concepts of interactive media sharing are described with reference to the MTSUD 102 and the CTSUD 104 described above.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the methods 1300 and 1350 are described is not intended to be construed as a limitation, and any number of the described method blocks can be combined in any order to implement the methods 1300 and 1350, or an alternative method. Additionally, individual blocks may be deleted from the methods without departing from the spirit and scope of the subject matter described herein. Furthermore, the methods 1300 and 1350 can be implemented in any suitable hardware, software, firmware, or combination thereof.

Referring to FIG. 13(a), at block 1302, a participant utilizing a MTSUD 102 may participate in a session where the session is conducted among a plurality of touch screen user devices (TSUDs) connected to each other, and wherein the plurality of TSUDs comprises at least one client touch screen user device (CTSUD).

At block 1304, the method may further include sending primary media content to one or more of the plurality of the TSUDs in real time where the primary media content comprises one or more of handwritten content provided through touch screen and multimedia data.

At block 1306, edited media content may be received from at least one of the plurality of the TSUDs in real time, wherein the edited media content comprises overlaid secondary media content on the primary media content and where the secondary media content comprises handwritten content provided through touch screen and multimedia data.

At block 1308, the edited media content may be provided to the one or more TSUDs of the session where the edited media content is projected on the touch screen of each of the one or more TSUDs in real time.

Referring to FIG. 13(b), at block 1352 a participant utilizing a CTSUD 104 may participate in a session where the session is conducted among a plurality of touch screen user devices (TSUDs) communicatively coupled to each other, and where the plurality of TSUDs includes at least one master touch screen user device (MTSUD).

At block 1354, primary media content may be received from one of the plurality of the TSUDs in real time. The primary media content may include text documents, PDF documents, presentations, chapters of e-book, scanned copy of physical material, question papers, quizzes, and inputs provided by the instructor on the e-canvas including handwritten descriptions, annotations, graphical inputs, and markup points.

At block 1356 secondary media content may be overlaid on the primary media content to generate edited media content in real time where the secondary media content is a true multimedia content comprising a handwritten content provided through touch screen and multimedia data.

At block 1358, the edited media content may be broadcasted among the plurality of the TSUDs in real time, wherein the broadcast may be controlled by the MTSUD.

Although embodiments for methods and systems for touch screen based interactive media sharing over a communication network have been described in a language specific to structural features and/or methods, it is to be understood that the invention is not necessarily limited to the specific features or methods described. Rather, the specific features and methods are disclosed as exemplary embodiments for touch screen based interactive media sharing.

I/We claim:

1. A method for interactive media sharing between a plurality of participants, each participant having a touch screen user device (TSUD), the method comprising:
participating in a session, wherein the session is conducted among a plurality of TSUDs communicatively coupled to each other, and wherein the plurality of TSUDs comprises at least one master touch screen user device (MTSUD);
receiving primary media content from at least one of the plurality of the TSUDs in real time;
overlaying secondary media content on the primary media content to generate edited media content in real time, wherein the secondary media content is true multimedia content comprising first handwritten content provided through a touch screen and first multimedia data; and
broadcasting the edited media content to the plurality of the TSUDs in real time, wherein the broadcast is controlled by the MTSUD.

2. The method as claimed in claim 1, wherein the method further comprises sending a message to the MTSUD in real time, wherein the message is overlaid on the edited media content, and wherein the message comprises one or more of second handwritten content provided through the touch screen and second multimedia data.

3. The method as claimed in claim 1, wherein the method further comprises sending one or more of second handwritten content provided through the touch screen and second multimedia data in real time to at least one TSUD.

4. The method as claimed in claim 2, wherein the message is one of an anonymous message and an onymous message.

5. The method as claimed in claim 1, wherein the method comprises saving the primary media content, the secondary media content and the edited media content after every pre-determined time period.

6. The method as claimed in claim 1, wherein the primary media content comprises one or more of text documents, PDF documents, presentations, chapters of e-books, scanned copy of physical material, question papers, quizzes, video content, and inputs provided through the TSUD on an e-canvas including handwritten descriptions, annotations, graphical inputs, and markup points.

7. A method for interactive media sharing between a plurality of participants, each participant having a touch screen user device (TSUD), the method comprising:
participating in a session, wherein the session is conducted among a plurality of touch screen user devices (TSUDs) communicatively coupled to each other, and wherein the plurality of TSUDs comprises at least one client touch screen user device (CTSUD);
sending primary media content to one or more of the plurality of the TSUDs in real time, wherein the primary media content comprises one or more of text documents, PDF documents, presentations, chapters of e-books, scanned copy of physical material, question papers, quizzes, video content, and inputs provided through the TSUD on an e-canvas including handwritten annotations, graphical inputs, and markup points;
receiving edited media content from at least one of the plurality of the TSUDs in real time, wherein the edited media content comprises secondary media content overlaid on the primary media content, and wherein the secondary media content comprises first handwritten content provided through a touch screen and first multimedia data; and
providing the edited media content to the one or more TSUDs of the session, wherein the edited media content is projected on the touch screen of each of the one or more TSUDs in real time.

8. The method as claimed in claim 7, wherein the first handwritten content provided through the touch screen is provided using one of a stylus and a touch gesture.

9. The method as claimed in claim 7, wherein the first handwritten content provided through the touch screen comprises one or more of text inputs, image inputs, scribbled inputs, and doodled inputs.

10. The method as claimed in claim 7, wherein the method further comprises receiving a message from one of the plurality of TSUDs in real time, and wherein the message is overlaid on the edited media content, and wherein the message comprises one or more of second handwritten content provided through the touch screen and second multimedia data.

11. The method as claimed in claim 7, wherein the method further comprises receiving one or more of second handwritten content provided through the touch screen and second multimedia data in real time from at least one TSUD.

12. The method as claimed in claim 7, wherein the method further comprises:
receiving inputs, from one or more of the plurality of the TSUDs in real time, on an e-canvas synchronously shared among the one or more of the plurality of the TSUDs; and
projecting the e-canvas on a display in real time, wherein the display is visible to users of the plurality of TSUDs.

13. A method for interactive media sharing between a plurality of participants, each participant having a touch screen user device (TSUD), the method comprising:
initiating a session among a plurality of touch screen user devices (TSUD), wherein the plurality of TSUDs comprises at least one master TSUD (MTSUD) and one or more client TSUDs (CTSUDs);
providing primary media content from the MTSUD to the one or more CTSUDs in real time wherein the primary media content comprises one or more of text documents, PDF documents, presentations, chapters of e-books, scanned copy of physical material, video content, and inputs provided through the TSUD on an e-canvas including handwritten annotations, graphical inputs, and markup points; and
providing edited media content from one of the CTSUD to the MTSUD in real time, wherein the edited media content comprises secondary media content overlaid on the primary media content, and wherein the secondary media content comprises first handwritten content provided through a touch screen and first multimedia data.

14. The method as claimed in claim 13, wherein the method further comprises saving the primary media content, the secondary media content and the edited media content after every predetermined time period.

15. The method as claimed in claim 13, wherein the method further comprises projecting the primary media content provided by the MTSUD on a display in real time, and wherein the display is visible to the participants.

16. The method as claimed in claim 13, wherein the method further comprises communicating messages between the plurality of TSUDs, wherein the messages comprises one or more of second handwritten content provided through the touch screen and second multimedia data.

17. A Master Touch Screen User Device (MTSUD) comprising:
a processor;
at least one touch screen coupled to the processor; and
a memory coupled to the processor, the memory comprising:
a MTSUD configuration module configured to allow participation in a session, wherein the session is conducted among a plurality of touch screen user devices (TSUDs) communicatively coupled to each other, and wherein the plurality of TSUDs comprises at least one client touch screen user device (CTSUD);
a MTSUD input processing module configured to send primary media content to one or more of the plurality of the TSUDs in real time, wherein the primary media content comprises one or more of text documents, PDF documents, presentations, chapters of e-books, scanned copy of physical material, video content, and inputs provided through the TSUD on an e-canvas including handwritten annotations, graphical inputs, and markup points; and
a MTSUD interaction module configured to:
receive edited media content from at least one of the plurality of the TSUDs in real time, wherein the edited media content comprises of secondary media content overlaid on the primary media content, and wherein the secondary media content comprises first handwritten content provided through a touch screen and first multimedia data; and
provide the edited media content to the one or more of the plurality of TSUDs, wherein the edited media content is projected on the touch screen of each of the one or more TSUDs in real time.

18. The MTSUD as claimed in claim 17, wherein the first handwritten content provided through the touch screen is provided through one of a stylus and a touch gesture.

19. The MTSUD as claimed in claim 17, wherein the MTSUD input processing module is further configured to analyze one or more of drag, flick finger, tap, tap and hold, lasso, lasso and cross, nudge, pinch, spread, slide finger, and scrunch touch gestures.

20. The MTSUD as claimed in claim 17, wherein the touch screen comprises an e-canvas for receiving inputs, and wherein the inputs comprises one or more of the first handwritten content provided through the touch screen and the first multimedia data.

21. The MTSUD as claimed in claim 17, wherein the MTSUD comprises at least two touch screens, and wherein the touch screens can swivel and change orientation.

22. The MTSUD as claimed in claim 17, wherein the MTSUD input processing module is further configured to provide unique digital paper (UDP), and wherein the UDP provides discontinuous page view of a document at any time instance.

23. A Client Touch Screen User Device (CTSUD) comprising:
a processor;
at least one touch screen coupled to the processor; and
a memory coupled to the processor, wherein the memory comprising:
a CTSUD configuration module configured to allow participation in a session, wherein the session is conducted among a plurality of touch screen user devices (TSUDs) communicatively coupled to each other, and wherein the plurality of TSUDs comprises at least one master touch screen user device (MTSUD);
a CTSUD interaction module configured to receive primary media content from one of the plurality of the TSUDs in real time; and
a CTSUD input processing module configured to overlay secondary media content on the primary media content to generate edited media content in real time, wherein the secondary media content is a true multimedia content comprising first handwritten content provided through a touch screen and first multimedia data.

24. The CTSUD as claimed in claim 23, wherein the CTSUD interaction module is further configured to broadcast the edited media content to the plurality of the TSUDs in real time, wherein the broadcast is controlled by the MTSUD.

25. The CTSUD as claimed in claim 23, wherein CTSUD is further configured to send a message to one or more of the plurality of TSUDs in real time, wherein the message is overlaid on the edited media content, and wherein the message comprises one or more of second handwritten content provided through touch screen and second multimedia data.

26. The CTSUD as claimed in claim 23, wherein the primary media content comprises one or more of text documents, PDF documents, presentations, chapters of e-books, scanned copy of physical material, question papers, quizzes, video content, and inputs provided through a TSUD on an e-canvas including handwritten annotations, graphical inputs, and markup points.

27. The CTSUD as claimed in claim 23, wherein the CTSUD input processing module is further configured to provide unique digital paper (UDP), and wherein the UDP provides discontinuous page view of a document at any time instance.

28. A Media Server (MS) to provide interactive media sharing between at least two participants, the MS comprising:
a processor; and
a memory coupled to the processor, wherein the memory comprising:
a MS configuration module configured to initiate a session among a plurality of touch screen user devices (TSUD), wherein the plurality of TSUDs comprises of at least one master TSUD (MTSUD) and one or more client TSUDs (CTSUDs); and
a communication module configured to:
provide primary media content from the MTSUD to the one or more CTSUDs in real time, wherein the primary media content comprises one or more of text documents, PDF documents, presentations, chapters of e-books, scanned copy of physical material, video content and inputs provided through a TSUD on the e-canvas including handwritten annotations, graphical inputs, and markup points; and
provide edited media content from one of the CTSUD to the MTSUD in real time, wherein the edited media content comprises secondary media content overlaid on the primary media content, and wherein the secondary media content comprises first handwritten content provided through a touch screen and first multimedia data.

29. The MS as claimed in claim 28, wherein the MS configuration module is further configured to save the primary media content, the secondary media content and the edited media content after every predetermined time period.

30. A computer-readable medium having embodied thereon a computer program for executing a method comprising:
participating in a session, wherein the session is conducted among a plurality of touch screen user devices (TSUDs) communicatively coupled to each other, and wherein the plurality of TSUDs comprises at least one client touch screen user device (CTSUD);
sending primary media content to one or more of the plurality of the TSUDs in real time, wherein the primary media content comprises one or more of text documents, PDF documents, presentations, chapters of e-books, scanned copy of physical material, video content and inputs provided through a TSUD on the e-canvas including handwritten annotations, graphical inputs, and markup points;
receiving edited media content from at least one of the plurality of the TSUDs in real time, wherein the edited media content comprises of secondary media content overlaid on the primary media content, and wherein the secondary media content comprises first handwritten content provided through a touch screen and first multimedia data; and
providing the edited media content to the one or more of the plurality of the TSUDs, wherein the edited media content is projected on the touch screen of each of the one or more TSUDs in real time.

31. A computer-readable medium having embodied thereon a computer program for executing a method comprising:
initiating a session among a plurality of touch screen user devices (TSUD), wherein the plurality of TSUDs comprises of at least one master TSUD (MTSUD) and one or more client TSUDs (CTSUDs);
providing primary media content from the MTSUD to the one or more CTSUDs in real time wherein the primary media content comprises one or more of text documents, PDF documents, presentations, chapters of e-books, scanned copy of physical material, and inputs provided through a TSUD on an e-canvas including handwritten annotations, graphical inputs, and markup points;
providing edited media content from one of the CTSUD to the MTSUD in real time, wherein the edited media content comprises secondary media content overlaid on the primary media content, and wherein the secondary media content comprises first handwritten content provided through the touch screen and first multimedia data; and
saving the primary media content, the secondary media content and the edited media content after every predetermined time period.
